(19) United States
(12) Patent Application Publication
(10) Pub. No.: US 2019/0005764 A1
(43) Pub. Date: Jan. 3, 2019

(54) REEL-BASED WAGERING GAMES

(71) Applicant: King Show Games Inc., Minnetonka, MN (US)

(72) Inventor: Ryan Strand, Hopkins, MN (US)

(21) Appl. No.: 16/019,988

(22) Filed: Jun. 27, 2018

Related U.S. Application Data
(60) Provisional application No. 62/526,540, filed on Jun. 29, 2017.

(51) Int. Cl. G07F 17/32; G07F 17/34

(52) U.S. Cl. CPC G07F 17/3213; G07F 17/3209; G07F 17/34; G07F 17/42; G07F 17/3248; G07F 17/3251; G07F 17/3246

(57) ABSTRACT

Reel-based wagering games and associated methods and gaming apparatuses are disclosed. Examples of reel-based wagering games comprise a number of reels and multiple paylines or a multi-way payout scheme associated with the number of reels. In some examples, evaluation of payouts associated with the multiple paylines or the multi-way payout scheme resets at a subsequent reel to stop after a first set of reels to stop results in a payout condition and the subsequent reel to stop does not correspond to a payout condition with the first set of reels to stop.

### RELATED APPLICATION

This application claims priority under 35 U.S.C. § 119(e) to U.S. Provisional Patent Application No. 62/526,540, which is entitled “REEL-BASED WAGERING GAMES,” was filed on Jun. 29, 2017, and the disclosure of which is hereby incorporated by reference.

### FIELD

The present disclosure relates to reel-based wagering games.

### BACKGROUND

Casino games such as poker, slots, and craps have long been enjoyed for entertainment. Almost any game of chance that can be played using traditional apparatus (e.g., cards, dice) can be simulated on a computer. The popularity of casino gambling with wagering continues to increase, as does recreational gambling such as non-wagering computer game gambling. It is also likely that most new games will be implemented, at least in part, using computerized apparatus.

One reason that casino games are widely implemented on computerized apparatus is that computerized games are highly adaptable, easily configurable and re-configurable, and require minimal supervision to operate. For example, the graphics and sounds included in such games can be easily modified to reflect popular subjects, such as movies and television shows.

Computer gaming devices can also be easily adapted to provide entirely new games of chance that might be difficult to implement using mechanical or discrete electronic circuits. Because of the ubiquity of computerized gaming machines, players have come to expect the availability of an ever-wider selection of new games when visiting casinos and other gaming venues. Playing new games adds to the excitement of “gaming.” As is well known in the art and as used herein, the term “gaming” and “gaming devices” generally involves some form of wagering, in that players make wagers of value, whether actual currency or something else of value, e.g., token or credit. Wagering-type games usually provide rewards based on random chance as opposed to skill. In some jurisdictions, the absence of skill when determining awards during game play is a requirement.

The present disclosure describes methods, systems, and apparatus that provide for new and interesting gaming experiences, and that provide other advantages over the prior art.

### SUMMARY

Reel-based wagering games and associated methods and gaming apparatuses are disclosed. Examples of reel-based wagering games comprise a number of reels and multiple paylines or a multi-way payout scheme associated with the number of reels. In some examples, evaluation of payouts associated with the multiple paylines or the multi-way payout scheme resets at a subsequent reel to stop after a first set of reels to stop results in a payout condition and the subsequent reel to stop does not correspond to a payout condition with the first set of reels to stop.

### BRIEF DESCRIPTION OF THE DRAWINGS

FIG. 1 is a representation of example reel-based wagering games having ten reels with multiple paylines.

FIG. 2 is a representation of an example game of FIG. 1, with all ten reels depicted in a changing state.

FIG. 3 is a representation of an example game of FIG. 1 in sequence with FIG. 2, with the left-most reel depicted in a stopped state.

FIG. 4 is a representation of an example game of FIG. 1 in sequence with FIGS. 2-3, with the two left-most reels depicted in stopped states and leading to a payout condition.

FIG. 5 is a representation of an example game of FIG. 1 in sequence with FIGS. 2-4, with all three left-most reels depicted in stopped states and leading to a payout condition.

FIG. 6 is a representation of an example game of FIG. 1 in sequence with FIGS. 2-5, with the four left-most reels depicted in stopped states, with the three left-most reels corresponding to a payout condition, and with the fourth reel not corresponding to the payout condition of the three left-most reels.

FIG. 7 is a representation of an example game of FIG. 1 in sequence with FIGS. 2-6, with the five left-most reels depicted in stopped states, with the three left-most reels corresponding to a first payout condition, and with the fourth and fifth reels leading to a second payout condition.

FIG. 8 is a representation of an example game of FIG. 1 in sequence with FIGS. 2-7, with the six left-most reels depicted in stopped states, with the three left-most reels corresponding to a first payout condition, and with the fourth through sixth reels corresponding to a second payout condition.

FIG. 9 is a representation of an example game of FIG. 1 in sequence with FIGS. 2-8, with the seven left-most reels depicted in stopped states, with the three left-most reels corresponding to a first payout condition, with the fourth through sixth reels corresponding to a second payout condition, and with the seventh reel not corresponding to a payout condition with the fourth through sixth reels.

FIG. 10 is a representation of an example game of FIG. 1 in sequence with FIGS. 2-6, with the five left-most reels depicted in stopped states, with the three left-most reels corresponding to a payout condition, with the fourth reel not corresponding to a payout condition, and with the fifth reel not corresponding to a payout condition with the fourth reel.

FIG. 11 is a representation of an example game of FIG. 1 in sequence with FIGS. 2-6 and 10, with the sixth left-most reels depicted in stopped states, with the three left-most reels corresponding to a payout condition, with the fourth reel not corresponding to a payout condition, and with the fifth and sixth reels leading to a payout condition.

FIG. 12 is a representation of an example game of FIG. 1 in sequence with FIGS. 2-6, 10, and 11, with the seven left-most reels depicted in stopped states, with the three left-most reels corresponding to a payout condition, with the fourth reel not corresponding to a payout condition, and with the fifth through seventh reels leading to a payout condition.

FIG. 13 is a representation of an example game of FIG. 1 in sequence with FIGS. 2-6 and 10-12, with the eight left-most reels depicted in stopped states, with the three left-most reels corresponding to a payout condition, with the fourth reel not corresponding to a payout condition, and with the fifth through eighth reels leading to a payout condition.

FIG. 14 is a representation of an example game of FIG. 1 in sequence with FIGS. 2-6 and 10-13, with the nine left-most reels depicted in stopped states, with the three left-most reels corresponding to a payout condition, with the fourth reel not corresponding to a payout condition, with the fifth through eighth reels corresponding to a payout condition, and with ninth reel not corresponding to the payout condition of the fifth through eighth reels.

FIG. 15 is a representation of an example game of FIG. 1 in sequence with FIGS. 2-6 and 10-14, with the three left-most reels corresponding to a payout condition, with the fourth reel not corresponding to a payout condition, with the fifth through eighth reels corresponding to a payout condition, and with ninth and tenth reels not corresponding to a payout condition.

FIG. 16 is another representation of an example game of FIG. 1 in sequence with FIGS. 2-6, with the five left-most reels depicted in stopped states, with the three left-most reels corresponding to a payout condition, with the fourth reel not corresponding to a payout condition, and with the fifth reel not corresponding to a payout condition with the fourth reel.

FIG. 17 is a representation of an example game of FIG. 1 in sequence with FIGS. 2-6 and 10, showing the fourth reel moved to become the right-most reel and available for resulting in a payout condition with preceding reels.

FIG. 18 is a representation of an example game of FIG. 1 with all ten reels depicted in stopped states, with the three left-most reels corresponding to a payout condition, with the third through seventh reels corresponding to a payout condition, with the fifth through eighth reels corresponding to a payout condition, and with the sixth through ninth reels corresponding to a payout condition.

FIG. 19 is another representation of an example game of FIG. 1, with the left-most reel depicted in a stopped state.

FIG. 20 is a representation of an example game of FIG. 1 in sequence with FIG. 19, with the two left-most reels depicted in stopped states and leading to a payout condition.

FIG. 21 is a front view of an example gaming apparatus.

FIG. 22 is a block diagram representing an example computer arrangement.

### DESCRIPTION

In the following description of various exemplary embodiments, reference is made to the accompanying drawings which form a part hereof, and in which are shown by way of illustration representative embodiments in which the features described herein may be practiced. It is to be understood that other embodiments may be utilized, as structural and operational changes may be made without departing from the scope of the disclosure.

In the description that follows, the term “reels” and similar mechanically descriptive language may be used to describe various apparatus presentation features, as well as various actions occurring to those objects (e.g., “spin” and “stop”). Although the present disclosure may be applicable to manual, mechanical, and/or computerized embodiments, as well as any combination therebetween, the use of mechanically descriptive terms is not meant to be only applicable to mechanical embodiments. Those skilled in the art will understand that, for purposes of providing gaming experiences to players, mechanical elements such as reels and the like may be simulated on a display in order to provide a familiar and satisfying experience that emulates the behavior of mechanical objects, as well as emulating actions that occur in non-computerized games (e.g., spinning and stopping reels). Further, a computerized version may provide the look of mechanical equivalents but may be generally randomized in a different way. Thus, the term “reel,” for example, is intended to describe both physical reels and emulation or simulations of physical reels and their behaviors using electronic apparatus.

In various embodiments, the gaming displays are described in conjunction with the use of data in the form of “symbols.” In the context of this disclosure, a “symbol” may generally refer at least to a collection of one or more arbitrary indicia or signs that have some conventional significance. In particular, the symbol represents values that can at least be used to determine whether to award a payout. A symbol may include numbers, letters, shapes, pictures, textures, colors, sounds, etc., and any combination therebetween. A win can be determined by comparing one symbol with another symbol.

Generally, such comparisons can be performed via software by mapping numbers (or other data structures such as character strings) to the symbols and performing the comparisons on the numbers/data structures.

Generally, the games and methods disclosed herein provide a player with two or more opportunities to win a discrete play of a game. Such games may be referred to as providing “second chance” opportunities, and the like. The games and methods disclosed herein may be implemented as a single game, or part of a multi-part game. For example, the game features disclosed herein may be implemented in primary gaming activities, bonus games, side bet games or other secondary games associated with a primary gaming activity. The game features may be implemented in stand-alone games, multi-player games, etc. Further, the disclosure may be applied to games of chance, and descriptions provided in the context of any representative game (e.g., slot game) are provided for purposes of facilitating an understanding of the features described herein. However, the principles described herein are equally applicable to any game of chance where an outcome(s) is determined for use in the player's gaming activity.

Reel-based wagering games and corresponding game methods are disclosed herein, with the reel-based wagering games indicated in the figures at 10 and generally referred to herein as reel-based wagering games 10, or just games 10. Reel-based wagering games 10 additionally or alternatively may be referred to as slots, video slots, slot games, slot machines, reel-based slot machines, and so forth. Games 10 may include any number of reels 12, with any number of symbols 14 associated with the reels 12. The presentation, representation, or display of a game 10 may be described as including a grid 16 of symbol positions 13, including two or more rows 18 and two or more columns 20, with individual columns 20 corresponding to individual reels 12, and with the displayed symbols 14 shown in the symbol positions 13 representing a subset of the total symbols 14 associated with all of the reels 12. The reels 12 may be displayed as stopped reels, with only a subset of symbols associated with a given reel being displayed. Additionally, the reels 12 may be displayed as changing reels, with the symbols associated with a given reel moving, such as in connection with a spinning reel in mechanical examples, or simply as changing symbols, whether simulating a mechanical reel or representing random or other representation of symbols.

In mechanical examples, the game reels 12 may include physical reel strips where game symbols 14 are shown in images fixed on the reel strips. Virtual reel strips may be mapped to these physical reel positions shown on the reel strips to expand the range or diversity of game outcomes. In video slot examples, reel strips may be encoded in a memory or database, and virtual reels may be used for the game reels with images representing the data related to the reel strips. In other slot machine embodiments, each symbol position 13 on the grid 16 may be associated with an independent reel strip. In yet other slot machine embodiments, reels and/or reel strips may not be used at all in determining the symbols shown in the symbol positions 13 of the grid. For example, a symbol 14 may be randomly selected for each symbol position 13 within the grid 16, or the symbols 14 may be determined in part by game events occurring during game play, such as displayed elements in the symbol positions 13 being replaced by new game elements or symbols. Numerous variations are possible for implementing slot-type game play.

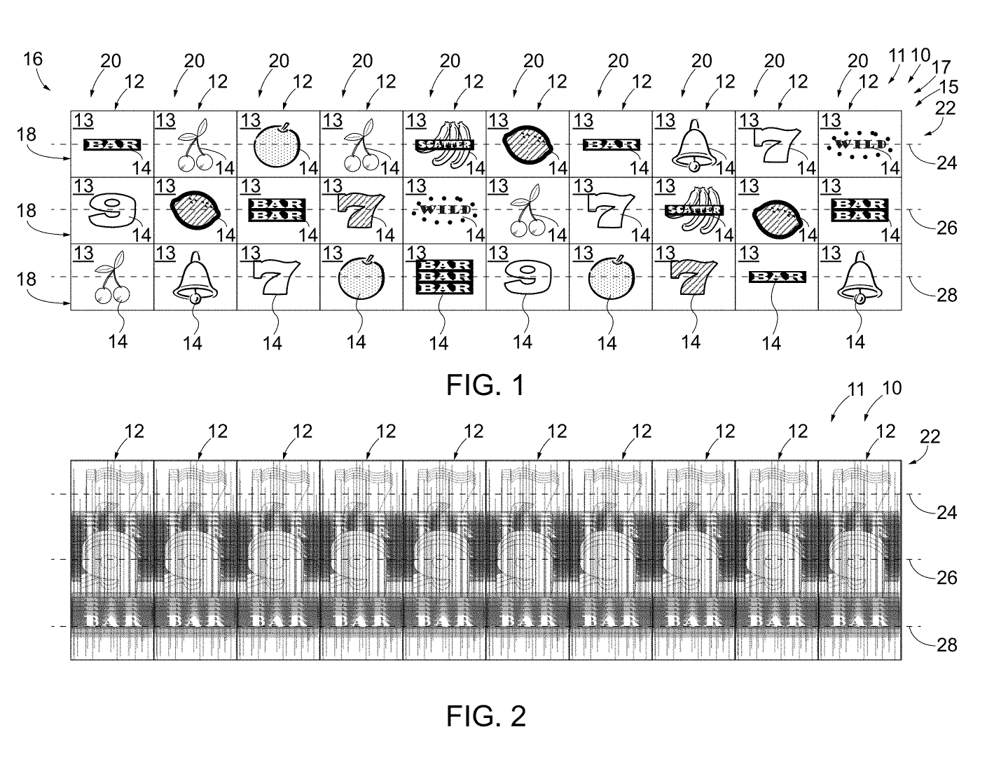

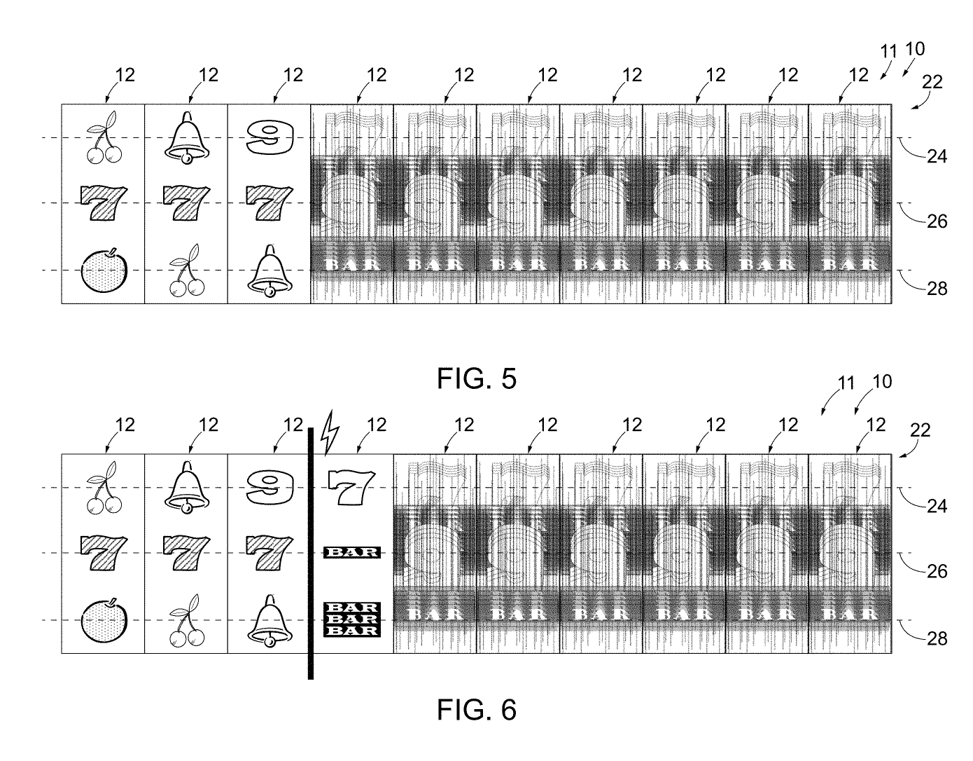

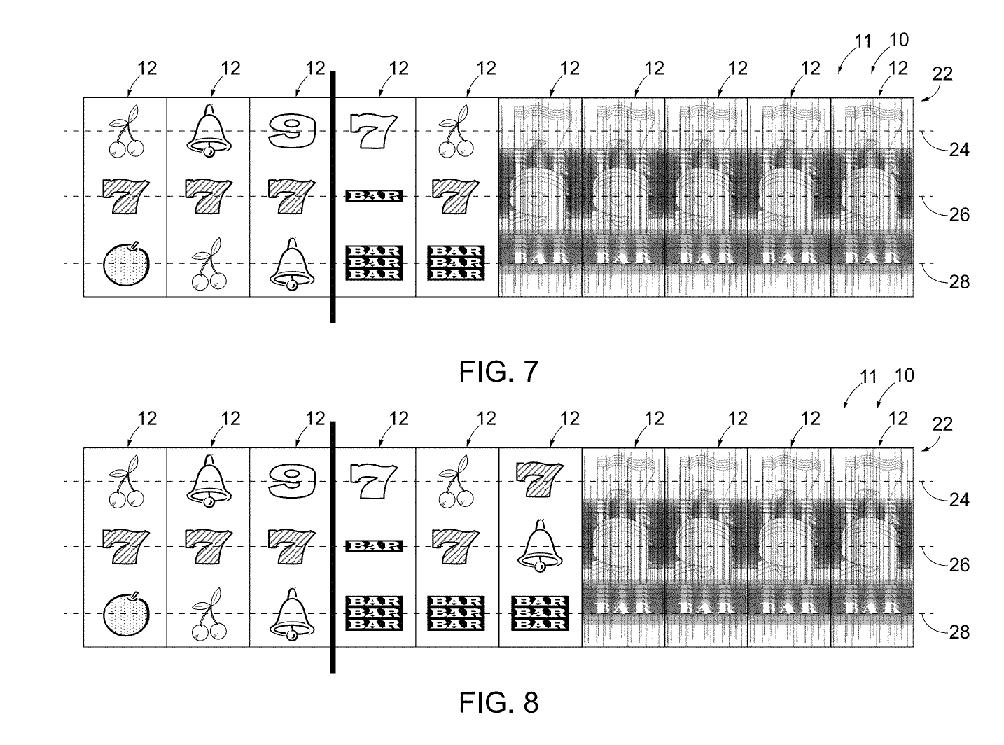

The example games 10 illustrated in FIGS. 1-17 have a grid 16 representing three rows 18 of symbols 14 from ten reels 12, resulting in a total of thirty displayed symbols 14 when all ten reels 12 are stopped, and are referred to herein as games 11; however, the features of example games 11 discussed herein may be applied to games 10 having any suitable size of grid 16 with any number of rows 18 and/or any number of reels 12.

Payout schemes associated with slots may include evaluations of symbol combinations associated with line pays along paylines 22, scatter pays, multi-way pays, or other types of symbol combination evaluation methods. In slot games that utilize line pays, the line payout schemes are often associated with one or more paylines 22, where each payline 22 corresponds to a predetermined arrangement or combination associated with predetermined symbol positions 13 within a game's grid 16. To ascertain whether a payout condition exists for a given game outcome, the game symbols 14 within the symbol positions 13 associated with a particular payline 22 may be evaluated to determine if a symbol combination is present that matches an entry in a paytable with an associated award. Any number of paylines 22 may be utilized in a game 10 according to the present disclosure, and for simplicity, games 11 are schematically shown having three paylines 22. More specifically, with respect to example games 11, a payline 24 is associated with the upper row 18 of symbols 14, a payline 26 is associated with the middle row 18 of symbols 14, and a payline 28 is associated with lower row 18 of symbols 14.

Although embodiments of games 10 that utilize paylines 22 as part of their payout schemes are described below in detail, other embodiments may use different payout schemes while still benefitting from the concepts described herein. For example, in embodiments where a game 10 utilizes multi-way payout schemes, similar principles of beginning the symbol combination evaluations at different starting points among the respective game reels 12 may be used. Thus, while the below description focuses on embodiments that utilize payline evaluation payout schemes, multi-way or other payout schemes may use similar techniques and are contemplated, as well.

Historically, most reel-based wagering games evaluate symbol combinations starting at the left-most game reel and then proceeding to the right (“left to right paying games”), although other games may evaluate symbol combinations beginning on the right-most reel and then proceeding to the left (“right to left paying games”) or evaluate both left to right and right to left (“both way paying games”). Although left to right paying game embodiments are described below in connection with example games 11, the described evaluation techniques similarly could be used for right to left paying game embodiments or both way paying game embodiments. Historically, for left to right paying games, the games generally only payout if the left-most stopped reel has at least one symbol that initiates or begins a symbol combination associated with an award in a paytable. Accordingly, after the second left-most reel stops, if no symbols of the second left-most stopped reel match or correspond to symbols on the left-most game reel along a payline (or within the entire left-most game reel for a multi-way pay evaluation game embodiment), then no payouts from the payline (or multi-way pay) evaluations can occur, and a player may lose interest in the game. This may be particularly true with games having five, six, or more total reels, because the player must wait for the rest of the game reels to stop to start a new play, even though no payout from the paylines (or multi-way pays) already has been determined. The features of games 10 herein overcome this deficiency of historical reel-based wagering games, as multiple opportunities for a payout are presented with the sequential stopping of reels 12.

With the above as a framework, some games 10 may be described as providing a player with more than one opportunity to win a discrete play of a game. For example, in games 10 in which reels 12 are sequentially stopped, a series of stopped reels 12 that do not result in a payout condition may reset the paylines 22 or otherwise initiate a new beginning of the paylines 22 (or beginning reel for a multi-way pay evaluation scheme) for evaluation of payout conditions according to a payout scheme. Stated differently, a “break” in paylines 22 may occur. For example, with reference to example games 11 and the sequence of FIGS. 2-6, as the reels 12 are sequentially stopped, the symbol combinations associated with paylines 22 are evaluated according to a payout scheme. In the illustrated example, the three left-most stopped reels each include a matching symbol along payline 26; however, the fourth reel has no matching symbols that otherwise result in a payout condition with the first three reels, and therefore evaluation of payout conditions associated with the fourth reel and the subsequent reels 12 begins anew at the fourth reel. Depending on the payout scheme of a game 11, the first three reels 12 with the three matching symbols along payline 26 may or may not result in a payout condition. For example, some games may include a paytable that provides awards for three-symbol combinations. In this example, the first three reels would correspond to a payout associated with the three shaded-7s along the middle horizontal payline 26, while still providing an opportunity for additional awards to be won in the grid. In other embodiments, some games 10 may require four or more matching symbols along a payline. Additionally or alternatively, some games 10 may result in a payout condition for only three matching symbols along a payline only when the matching symbols fall within a predetermined subset of the symbols associated with the game, such as being, for example, major symbols.

Stated differently, a reel-based wagering game method according to the present disclosure may comprise displaying changing reels, then sequentially stopping the changing reels to display stopped reels, and evaluating whether the displayed game symbols of the first X stopped reels correspond to a first predetermined arrangement of game symbols that lead to a first payout condition (e.g., matching symbols of the first X stopped reels along a payline or matching symbols of the first X stopped reels in any displayed position on adjacent reels for a multi-way payout scheme), where X is an integer corresponding to a minimum number of reels (or symbols along a payline) required to lead to any payout condition. In the example games 11 depicted in the figures and discussed herein, X is three; however, X may be three, four, five, six, or more than six depending on the game 10 being implemented. With reference to the example sequence of FIGS. 2-5, with X equal to three, the first (left-most) three stopped reels correspond to a payout condition with the shaded-7 symbols along payline 26. Accordingly, in this example, the evaluation of the first X stopped reels results in an affirmative condition.

Such a reel-based wagering game method may further comprise, responsive to the displayed game symbols of the first X stopped reels corresponding to the first predetermined arrangement of game symbols (e.g., the affirmative condition of the example of the sequence of FIGS. 2-5), evaluating whether the displayed game symbols of the first X+1 stopped reels correspond to a second predetermined arrangement of game symbols that lead to a second payout condition (e.g., matching symbols of the first X+1 stopped reels along a payline or matching symbols of the first X+1 stopped reels in any displayed position for a multi-way payout scheme). For example, with reference to the sequence of FIGS. 2-6, an evaluation of the fourth (left-most) stopped reel results in a negative condition, in that a shaded-7 symbol is not present along payline 26 on the fourth stopped reel. Accordingly, in this example, the evaluation of the paylines 22 and/or a multi-way payout scheme resets with the fourth stopped reel.

In such examples of reel-based wagering game methods, the method may further comprise, responsive to the displayed game symbols of the first X+1 stopped reels not corresponding to the second predetermined arrangement of game symbols, evaluating whether the displayed game symbols of the (X+1)th stopped reel through the (X+X)th stopped reel correspond to a third predetermined arrangement of game symbols that lead to a third payout condition (e.g., matching symbols of the (X+1)th stopped reel through the (X+X)th stopped reel along a payline or matching symbols of the (X+1)th stopped reel through the (X+X)th stopped reel in any displayed position for a multi-way payout scheme). For example, with reference to the sequence of FIGS. 2-8, an evaluation of the fourth (left-most) stopped reel through the sixth (left-most) stopped reel results in an affirmative condition, in that these stopped reels include matching triple-bar symbols along payline 28. However, in the example sequence of FIGS. 2-6, 10, and 11, an evaluation of the fourth (left-most) stopped reel through the sixth (left-most) stopped reel results in a negative condition, in that these stopped reels do not include matching symbols along a payline 22.

In some implementations of games 10 and corresponding methods, the game may result in no further opportunities for payout according to a primary payout scheme if the (X+1)th stopped reel through the (X+X)th stopped reel does not correspond to a payout condition, or if a subsequent reel does not lead to a payout condition with preceding reels that do lead to a payout condition (optionally with the preceding reels including more than X reels). That is, in some games 10 and corresponding methods each sequential set of X reels must either result in a payout or lead to a payout for evaluation of a primary payout scheme to continue. Moreover, in some such examples, at least the first X reels must result in a payout for evaluation of the primary payout scheme to continue. For example, in the example sequence of FIGS. 2-6 and 10, because the fourth (left-most) stopped reel and the fifth (left-most) stopped reel do not have matching symbols along any payline 22, evaluation of payouts may effectively cease with the fifth stopped reel. However, in other examples of games 10 and corresponding methods, subsequent opportunities for payout may result even when a sequential set of X reels does not result in or lead to a payout condition. For example, in the sequence of FIGS. 2-6 and 10-14, despite the fifth (left-most) stopped reel not leading to a payout condition with the fourth (left-most) stopped reel, evaluation of payout begins anew at the fifth (left-most) stopped reel, and in the illustrated example results in a payout associated with matching symbols (i.e., cherries) along payline 24 on the fifth through eighth (left-most) stopped reels.

Reel-based wagering game methods may further comprise, responsive to the displayed game symbols of the first X+1 stopped reels corresponding to the second predetermined arrangement of game symbols, evaluating whether the displayed game symbols of the first X+2 stopped reels correspond to a fourth predetermined arrangement of game symbols that lead to a fourth payout condition (e.g., matching symbols of the first X+2 stopped reels along a payline or matching symbols of the first X+2 stopped reels in any displayed position on adjacent reels for a multi-way payout scheme). In other words, evaluation for increased payout continues so long as a predetermined criterion (e.g. matching symbols) is met as reels are sequentially stopped.

Some reel-based wagering game methods further comprise, responsive to one or more of the first payout condition, the second payout condition, the third payout condition, or the fourth payout condition having been satisfied, increasing a credit balance. In other words, when payout conditions are met, a player's credit balance ultimately may be increased.

In some games 10, the game is configured to alert a player when a stopped reel triggers the initiation of new paylines or the new beginnings of the paylines (or beginning reel for a multi-way pay evaluation scheme), such as in the example of FIG. 6 upon the fourth reel stopping. Such an alert additionally or alternatively may be described as alerting the player when a subsequently stopped reel resets a payline (or beginning reel for a multi-way pay evaluation scheme), for example, to maintain the player's attention despite the stopped reel not necessarily leading to a payout with the prior stopped reels. Additionally or alternatively, such an alert may alert the player that a segment of a payline has terminated, with the preceding reels evaluated for a payout condition. Such an alert may take the form of a visual alert and/or an audible alert. Illustrative, non-exclusive examples of visual alerts include displaying a symbol and visually separating adjacent reels or adjacent symbol positions along a payline. In the example illustrated in FIG. 6, two optional forms of visual alerts are presented, including the display of a lightning bolt associated with the fourth reel (e.g., visually indicating a “strike”) and including the display of a vertical line between the third reel and the fourth (e.g., visually indicating a “break,” reset, or new start, of the paylines). However, other forms of visual alerts may be used, including only one of the example alerts presented in the figures herein.

Stated differently, some reel-based wagering game methods according to the present disclosure further comprise, responsive to the displayed game symbols of the first X+1 stopped reels not corresponding to the second predetermined arrangement of game symbols, alerting a player that a new evaluation of payout begins with the (X+1)th stopped reel. Additionally or alternatively, some reel-based wagering game methods according to the present disclosure comprise alerting a player that a new evaluation of payout associated with a first payline (i.e., with a single payline) of the plurality of paylines begins with the (X+1)th stopped reel.

By alerting the player that the paylines have been reset or begun anew (or that a beginning reel for a multi-way pay evaluation scheme has been reset), particularly in examples where the prior stopped reels do not result in a payout condition, the player versed in the elements of the game will understand that new opportunities to achieve a payout are triggered, thus maintaining the player's interest in the game. In some examples, the visual alert may remain for the duration of a discrete game play, such as with the example vertical line shown in the example sequence of FIGS. 6-9 and in the example sequence of FIGS. 6 and 10-15. In other examples, the visual alert may remain for less than the duration of a discrete game play, such as only until a subsequent reel stops, or until such time that a new visual alert is presented in connection with another reset of the paylines (or beginning reel for a multi-way pay evaluation scheme).

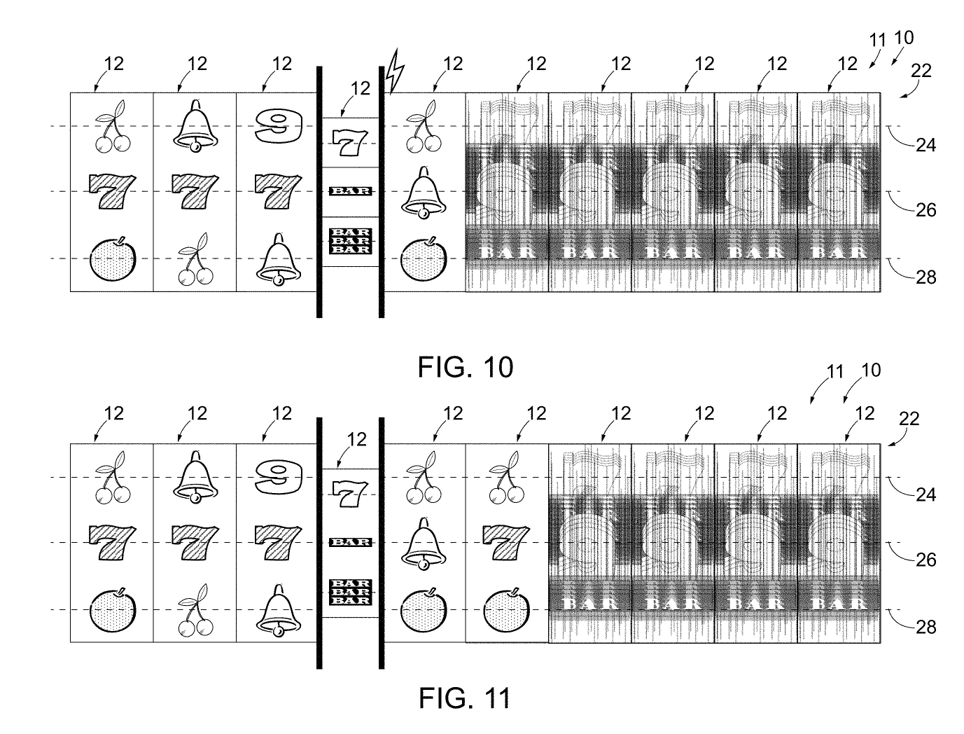

Additionally or alternatively, an optional visual alert may be triggered when one or more stopped reels cannot result in a payout condition based on the payout scheme of the game. As an illustrative, non-exclusive example, the display of the reel or reels that do not lead to, or result in, a payout condition may be reduced in size, such as shown in connection with the fourth reel in FIGS. 10-15. In FIG. 6, the display of the fourth reel has not yet been reduced in size, because the fifth reel has not yet stopped for determination of whether or not the fourth reel has the potential to result in a payout condition.

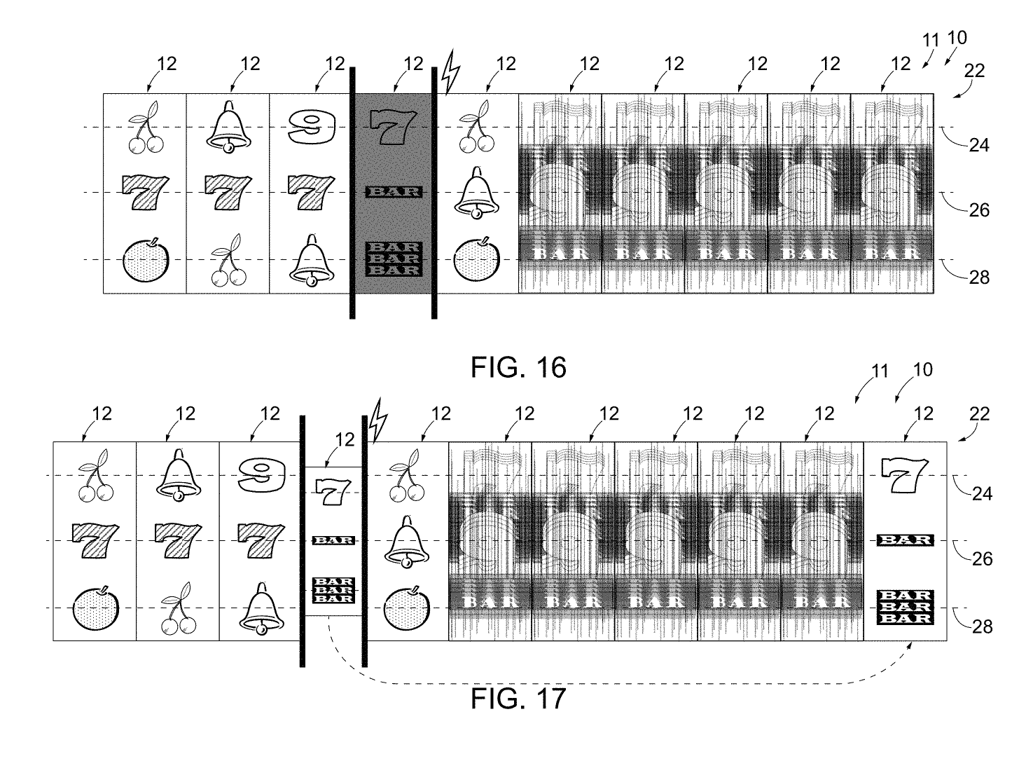

Yet another optional example of a visual alert that is triggered when one or more stopped reels cannot result in a payout condition based on the payout scheme of the game includes changing the color, changing the shading, changing the contrast, adding cross-hatching, or changing or adding any other visual alert to a stopped reel that does not lead to a payout. FIG. 16 illustrates such a visual alert analogous to the position of FIG. 10 in the sequence of FIGS. 2-6 and 10.

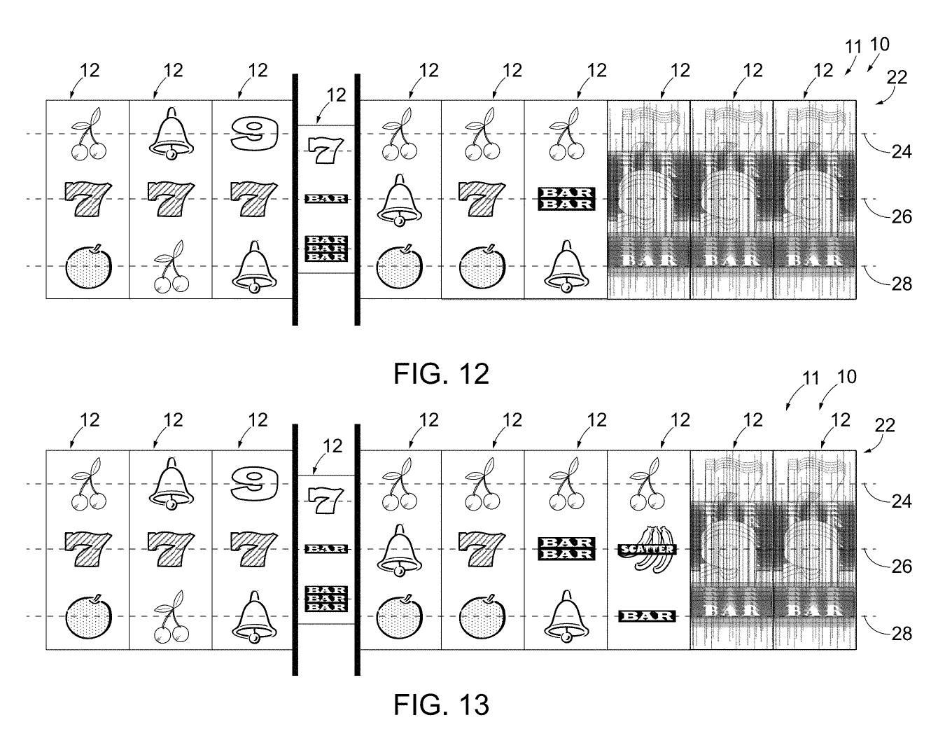

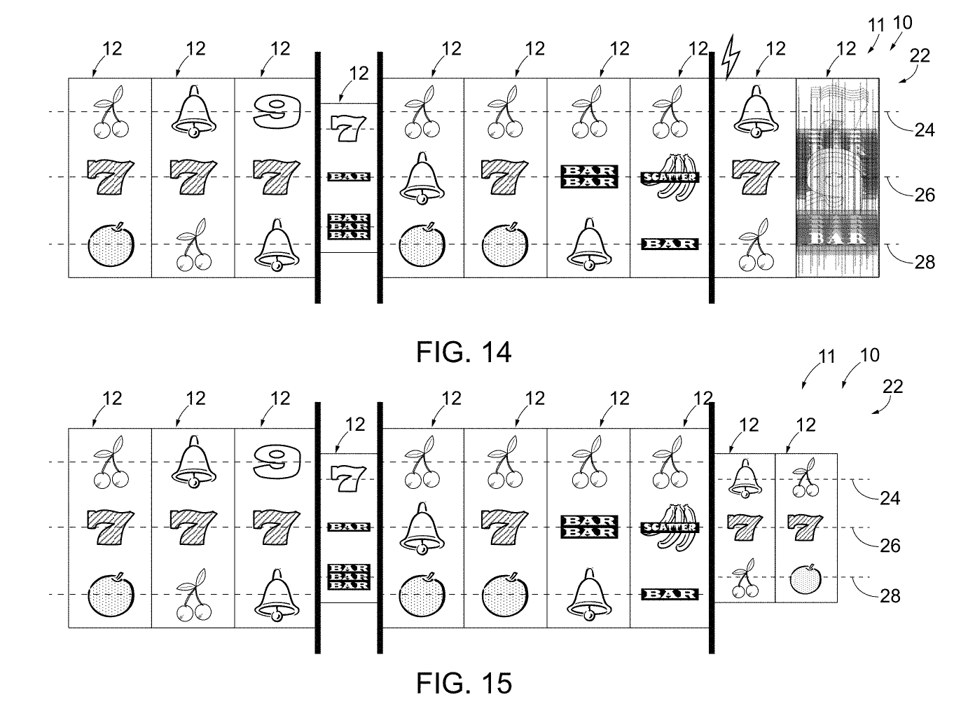

Continuing with the example sequence of FIGS. 2-6 and 10-15, in FIG. 11, the sixth reel has stopped with a symbol (cherries) along payline 24 matching the preceding reel. Because the fifth and sixth reels have the potential to lead to a payout condition, no alert results and play continues. In FIG. 12, the seventh reel has stopped with a symbol (cherries) along payline 24 matching the two preceding reels and thus triggering a payout condition, leading to a payout condition, or leading to a greater payout condition, depending on the payout scheme of the game. Again, no alert results and play continues. In FIG. 13, the eighth reel has stopped with a symbol (cherries) along payline 24 matching the three preceding reels and thus again triggering a payout condition, leading to a payout condition, or leading to a greater payout condition, depending on the payout scheme of the game. In FIG. 14, the ninth reel has stopped with no symbols along paylines 22 matching the immediately preceding reels. Thus, at least in the example payout scheme associated with the depicted example (and corresponding to a payline version of a game 10), evaluation of payout conditions associated with the ninth reel and the subsequent reels 12 begins anew at the ninth reel, and a visual alert is presented to the player. Additionally or alternatively, the alert associated with the ninth reel may be described as alerting the player as to the termination of the prior segment of the paylines, for example, if in the game, the remaining reels simply cannot lead to a payout condition due to the number of reels and the associated payout scheme. For example, in some games 10, three or more reels may be required to have matching, or other predetermined arrangement, of symbols to result in a payout condition. In FIG. 15, the tenth and final reel has stopped, and the ninth and tenth reels have been reduced in size to visually indicate that the ninth and tenth reels do not result in a payout condition.

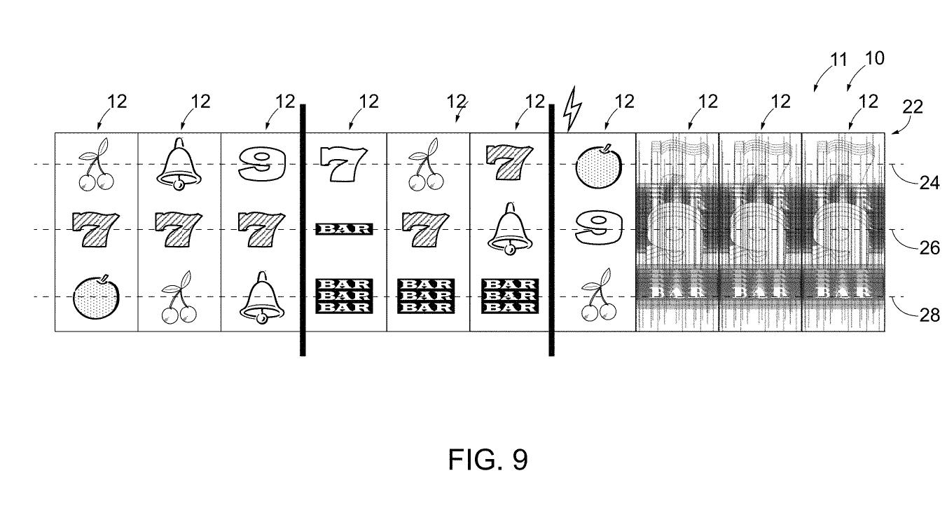

Similarly, in the example sequence of FIGS. 2-8, the fifth and sixth reels have stopped with a symbol (triple-bar) along payline 28 matching the preceding reel. Because the fourth through sixth reels lead to a payout condition (e.g., when X is equal to three) and because there is still an opportunity for an increased payout (e.g., if the seventh reel stops with a matching (triple-bar) symbol along payline 28, no alert results and play continues. In FIG. 9, however, the seventh reel has stopped without a matching (triple-bar) symbol along payline 28, and therefore a visual alert is presented to the player.

FIG. 17 depicts an optional and alternative configuration of games 11 corresponding to the position of FIG. 10 in the sequence of FIGS. 2-6 and 10. For example, in some games 10, a stopped reel that is not part of any payout under a normal left-to-right sequence of reels along a payline 22 may be moved or replicated to a right-most position of the reels 12 to be reevaluated for a payout condition with the preceding reels. Additionally or alternatively, the moved or replicated reel may be respun, either automatically by the game or responsive to a player input to respin the moved reel. Other examples of reusing reels that are not part of any existing payout also may be incorporated into games 10.

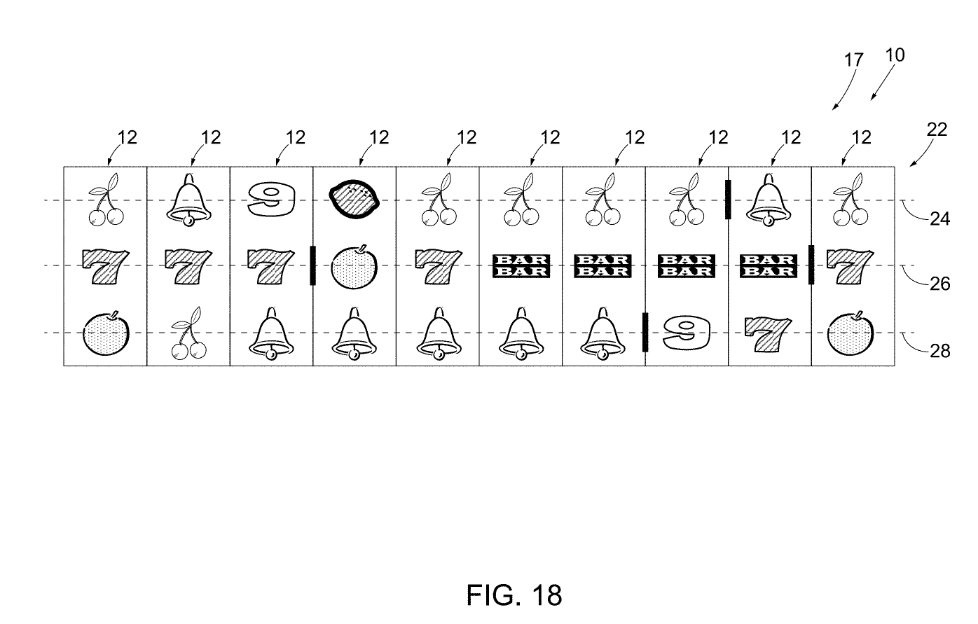

The embodiments described above with respect to FIGS. 2-17 include a clear “break” in the game grid 16 when a reel 12 is stopped that cannot form or continue a symbol combination with a preceding reel (reel to the left in left to right paying games) where paylines are reset or started anew for symbol combination evaluations. However, other embodiments may provide this “break” with respect to each individualized payline 22 rather than as to the grid 16 as a whole. For example, FIG. 18 illustrates an example game 10, referred to herein as games 17, in which “breaks” are associated, not with entire reels 12 (or columns 20), but rather with individual paylines 22.

In the example game 17 represented in FIG. 18, the shaded-7 symbols along payline 26 have ended when the fourth reel 12 stopped and a shaded-7 symbol was not in the middle position. Accordingly, a “break” in payline 26 occurs between the third and fourth reels with evaluation of payline 26 resetting or beginning anew at reel four, but with other paylines 22 not necessarily being affected depending on the symbols displayed along the other paylines 22. For example, the lower horizontal payline 28 started with a bell symbol when the third reel stopped and continued with bell symbols appearing in the lower position of the fourth reel, fifth reel, sixth reel, and seventh reel along the lower payline 28. Accordingly, a “break” in payline 28 did not occur at the same point as the break in payline 26 (i.e., between the third and fourth reels), but did occur between the seventh and eighth reels with evaluation of payline 28 resetting or beginning anew at reel eight. Hence, because the “breaks” are associated with individual paylines instead of the vertical columns (reels 12 in this embodiment) within the grid 16, symbol combination strings may overlap particular columns (reels 12) at the same or different symbol positions within the grid. Additionally, as shown in FIG. 18, double-bar symbols appear along the middle payline 26 in the sixth, seventh, eighth, and ninth reels 12. Thus, in the embodiment shown in FIG. 18, the player may be paid for the three shaded-7 symbol combination and four double-bar symbol combination along the middle payline 26, be paid for the four cherry symbol combination along the top payline 24, and be paid for the five bell symbol combination along the bottom payline 28. That is, in games 17, more than one payout may result along a single payline 22.

In the example game 17 depicted in FIG. 18, a visual alert of the “breaks” are depicted in the form of a vertical line at each location of “break.” However, other forms of visual and audible alerts, as discussed herein, also may be implemented in connection with games 17.

In embodiments that use a multi-way pay scheme, a similar evaluation mechanic as that used in connection with the example game 17 discussed above in connection with FIG. 18 may be used where the “break” is made with respect to the individual symbols or symbol types instead of the columns or reels 12 of the game grid 16.

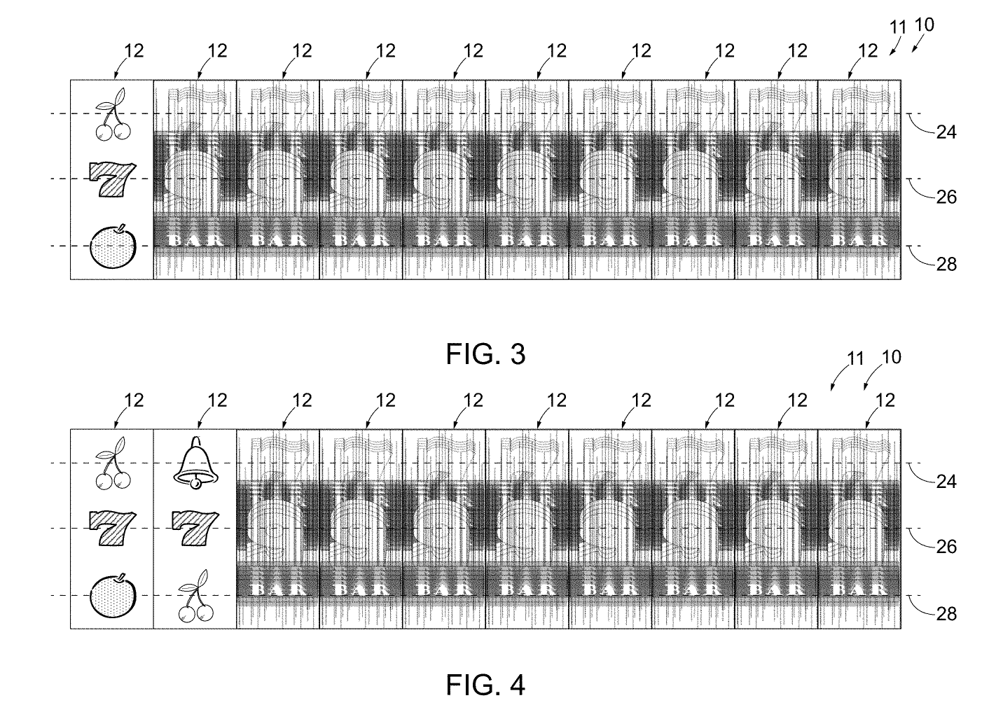

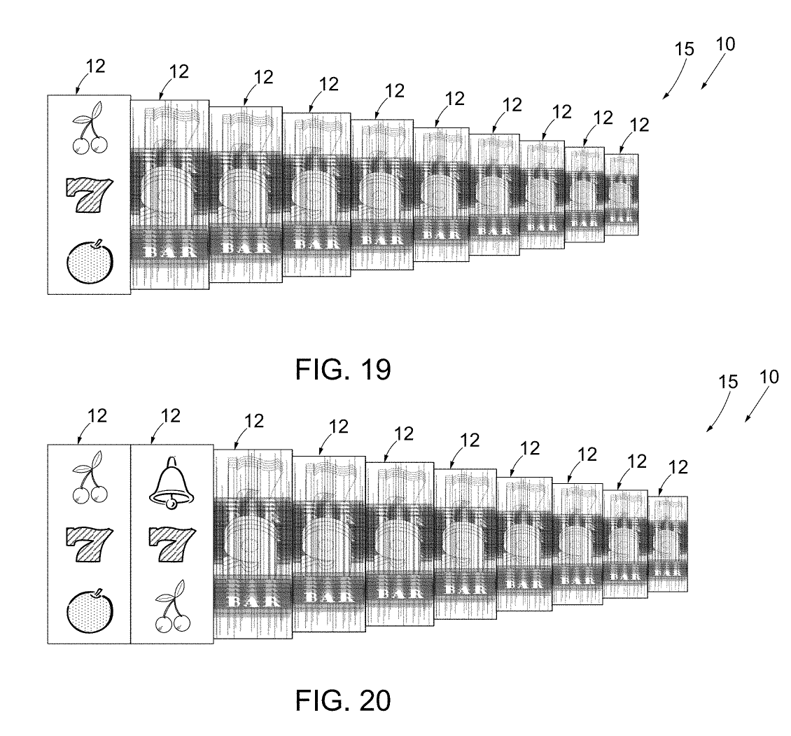

FIGS. 19 and 20 illustrate an example game 10, referred to herein as game 15. Similar to games 11 and 17, game 15 has ten reels 12, but presents a different visual presentation of the reels during gameplay. FIGS. 19 and 20 correspond to the sequence of FIGS. 3 and 4 of games 11; however, rather than initially presenting all reels 12 as the same size, the reels 12 are initially presented in a tiered fashion with the reels being reduced in size from left to right. As a reel stops, it increases in size to match the preceding stopped reels, and subsequent reels each increase in size to the prior size of the respective preceding reels. Alternatively, all reels may continuously increase in size until they are stopped. Other variations on the visual presentation of reels 12 of games 10 also are within the scope of the present disclosure, and the various functions of games 10 described herein may be implemented in any such variations.

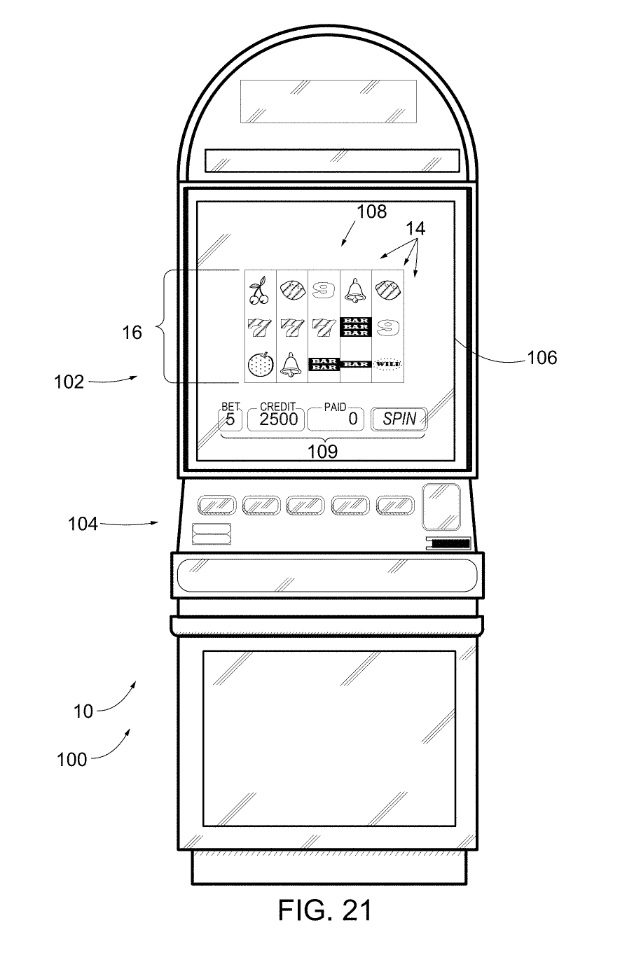

Turning now to FIG. 21, an example gaming apparatus 100 that may embody a game 10 and implement a method according to the present disclosure is depicted. The gaming apparatus includes a display area 102 (also referred to as a gaming display), and a player interface area 104 (also referred to as a user interface), although some or all of the interactive mechanisms included in the player interface area 104 may be provided via graphical icons used with a touch screen in the display area 102 in some embodiments. The display area 102 may include one or more game displays 106 (also referred to as “displays” or “gaming displays”) that may be included in physically separate displays or as portions of a common large display. Here, the game display 106 includes a primary game play portion 108 that displays game elements and symbols 14 such as associated with games 10, and an operations portion 109 that can include meters, various game buttons, or other game information for a player of the gaming apparatus 100.

The user interface 104 allows the user to control and engage in play of the gaming apparatus 100 and thus of games 10. The particular user interface mechanisms included with user interface 104 may be dependent on the type of gaming device. For example, the user interface 104 may include one or more buttons, switches, joysticks, levers, pull-down handles, trackballs, voice-activated input, touch screens (including, e.g., the game display 102), or any other user input system or mechanism that allows the user to play the particular gaming activity.

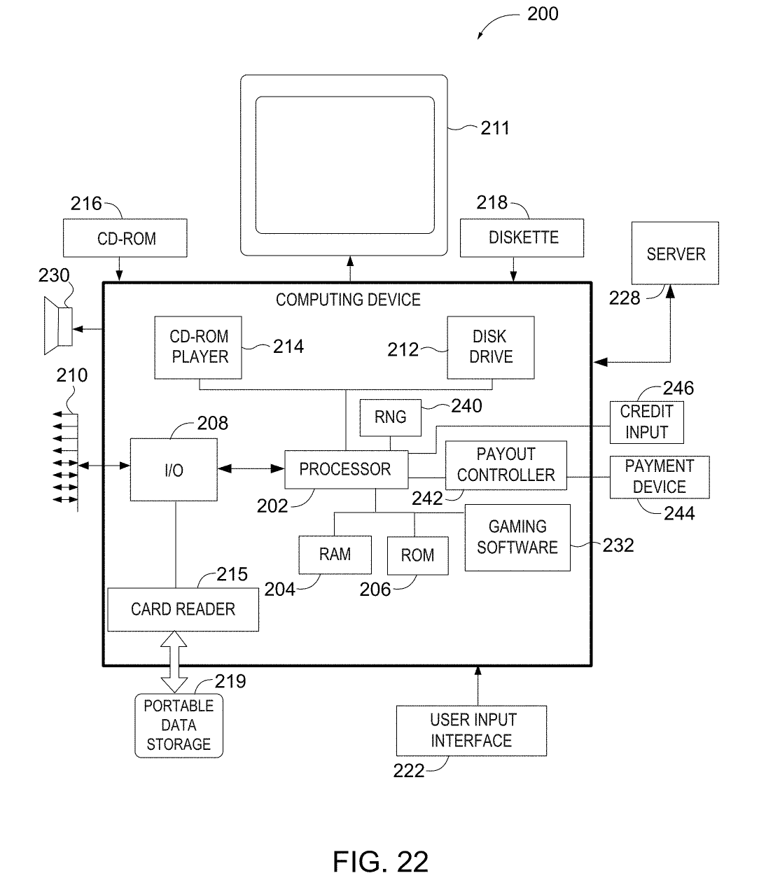

The user interface 104 may allow the user or player to enter coins, bills, or otherwise obtain credits through vouchers, tokens, credit cards, tickets, etc. Various mechanisms for entering such vouchers, tokens, credit cards, coins, tickets, etc. are described below with reference to FIG. 22. For example, currency input mechanisms, card readers, credit card readers, smart card readers, punch card readers, radio frequency identifier (RFID) readers, and other mechanisms may be used to enter wagers. The user interface 104 also may include a mechanism to read and/or validate player loyalty information to identify a user or player of the gaming device. This mechanism may be a card reader, biometric scanner, keypad, or other input device. It is through the user interface 104 that the player can initiate and engage in gaming activities. While the illustrated embodiment depicts various buttons for the user interface 104, it should be recognized that a wide variety of user interface options are available for use in connection with games 10 and gaming apparatus 100, including pressing buttons, touching a segment of a touch-screen, entering text, entering voice commands, or other known data entry methodology.

The game display 106 in the display area 102 may include one or more of an electronic display, a video display, a mechanical display, and fixed display information, such as paytable information associated with a glass/plastic panel on the gaming machine 100 and/or graphical images. The symbols or other indicia associated with the play of the game may be presented on an electronic display device or on mechanical devices associated with a mechanical display. Generally, the display 106 devotes the largest portion of viewable area to the primary gaming portion 108. The primary gaming portion 108 is generally where the visual feedback for any selected game is provided to the user. The primary gaming portion 108 may render graphical objects such as cards, slot reels, dice, animated characters, and any other gaming visual known in the art. The primary gaming portion 108 also typically informs players of the outcome of any particular event, including whether the event resulted in a win or loss.

In connection with games 10, the primary gaming portion 108 may display grid 16 (or an equivalent arrangement) of game symbols 14.

The primary gaming portion 108 may include other features known in the art that facilitate gaming, such as operations portion 109. As is generally known in the art, the operations portion 109 provides information about current bets, current wins, remaining credits, etc. associated with gaming activities of the grid 16 of game symbols 14. The operations portion 109 also may provide touchscreen controls for facilitating game play. The grid 16 also may include touchscreen features, such as facilitating selection of individual symbols, or user controls over stopping or spinning/changing reels. The game display 106 of the display area 102 may include other features that are not shown, such as paytables, navigation controls, etc.

Although FIG. 21 illustrates a particular implementation of a gaming apparatus 100 that embodies a game 10 in the form of a casino or electronic gaming machine (“EGM”), one or more devices may be programmed to play various embodiments of games 10. That is, games 10 may be implemented, as shown in FIG. 21, as a casino gaming machine or other special purpose gaming kiosk as described herein, or may be implemented via computing systems operating under the direction of local gaming software, and/or remotely-provided software such as provided by an application service provider (ASP). Casino gaming machines also may utilize computing systems to control and manage the gaming activity, although these computing systems typically include specialized components and/or functionality to operate the particular elements of casino gaming machines. Additionally, computing systems operating over networks, such as the Internet, also may include specialized components and/or functionality to operate elements particular to these systems, such as random number generators. An example of a representative computing system capable of carrying out operations in accordance with games 10 is illustrated in FIG. 22.

Hardware, firmware, software or a combination thereof may be used to perform the various gaming functions, display presentations and operations described herein. The functional modules used in connection with games 10 may reside in a gaming machine as described, or may alternatively reside on a stand-alone or networked computer. The computing structure 200 of FIG. 22 (also referred to as computing arrangement and computing device) is an example computing structure that may be used in connection with such electronic gaming machines, computers, or other computer-implemented devices to carry out operations of games 10. Although numerous components or elements are shown as part of this computing structure 200 in FIG. 22, additional or fewer components may be utilized in particular implementations of games 10.

The example computing arrangement 200 suitable for performing the gaming functions in accordance with games 10 typically includes a central processor (CPU) 202 coupled to random access memory (RAM) 204 and some variation of read-only memory (ROM) 206. Processor 202, either alone or together with one or more additional components of a computing arrangement, may be described as a controller. The ROM 206 also may represent other types of storage media to store programs, such as programmable ROM (PROM), erasable PROM (EPROM), etc. The processor 202 may communicate with other internal and external components through input/output (I/O) circuitry 208 and bussing 210, to provide control signals, communication signals, and the like.

The computing arrangement 200 also may include one or more data storage devices, including hard and floppy disk drives 212, CD-ROM drives 214, a card reader 215, and other hardware capable of reading and/or storing information such as DVDs, etc. In one embodiment, software for carrying out the operations in accordance with games 10 may be stored and distributed on a CD-ROM 216, diskette 218, or portable data storage 219, such as in the form of an access card, or other form of computer readable media capable of portably storing information. These storage media may be inserted into, and read by, devices such as the CD-ROM drive 214, the disk drive 212, card reader 215, etc. The software also may be transmitted to the computing arrangement 200 via data signals, such as being downloaded electronically via a network, such as a local area network (e.g., a casino, property, or bank network) or a wide area network (e.g., the Internet). Further, as previously described, the software for carrying out the functions associated with games 10 alternatively may be stored in internal memory/storage of the computing device 200, such as in the ROM 206.

The computing arrangement 200 is coupled to the display 211, which represents a display on which the gaming activities in accordance with games 10 are presented. The display 211 represents the “presentation” of the game information in accordance with games 10, and may be a mechanical display showing physical spinning reels, a video display, such as liquid crystal displays, plasma displays, cathode ray tubes (CRT), digital light processing (DLP) displays, liquid crystal on silicon (LCOS) displays, etc., or any type of known display or presentation screen.

Where the computing device 200 represents a stand-alone or networked computer, the display 211 may represent a standard computer terminal or display capable of displaying multiple windows, frames, etc. Where the computing device 200 represents a mobile electronic device, the display 211 may represent the video display of the mobile electronic device. Where the computing device 200 is embedded within an electronic gaming machine, such as a gaming apparatus 100, the display 211 corresponds to the game display 106 of the gaming machine/kiosk.

A user input interface 222 such as a mouse, keyboard/keypad, microphone, touch pad, trackball, joystick, touch screen, voice-recognition system, card reader, biometric scanner, RFID detector, etc. may be provided. The user input interface 222 may be used to input commands in the computing arrangement 200, such as placing wagers or initiating gaming events on the computing arrangement 200, inputting currency or other payment information to establish a credit amount or wager amount, or inputting data to identify a player for a player loyalty system. The display 211 also may act as a user input device, e.g., where the display 211 is a touchscreen device. In some embodiments, where the computing device 200 is implemented in a personal computer, tablet, smart phone, or other consumer electronic device, the user interface and display may be the available input/output mechanisms related to those devices.

Chance-based gaming systems such as slot machines, in which games 10 are applicable, are governed by random numbers and processors, as facilitated by a random number generator (RNG). The fixed and dynamic symbols generated as part of a gaming activity may be produced using one or more RNGs. RNGs may be implemented using hardware, software operable in connection with the processor 202, or some combination of hardware and software. Games 10 are operable using any known RNG, and may be integrally programmed as part of the processor 202 operation, or alternatively may be a separate RNG controller 240. The RNGs often are protected by one or more security measures to prevent tampering, such as by using secured circuitry, locks on the physical game cabinet, and/or remote circuitry that transmits data to the gaming device.

The computing arrangement 200 may be connected to other computing devices or gaming machines, such as via a network. The computing arrangement 200 may be connected to a network server 228 in an intranet or local network configuration. The computer may further be part of a larger network configuration as in a global area network (GAN) such as the Internet. In such a case, the computer may have access to one or more web servers via the Internet. In other arrangements, the computing arrangement 200 may be configured as an Internet server and software for carrying out the operations in accordance with games 10 may interact with the player via one or more networks. The computing arrangement 200 also may be operable over a social network or other network environment that may or may not regulate the wagering and/or gaming activity associated with gaming events played on the computing arrangement.

Other components directed to gaming machine implementations include manners of gaming participant payment, and gaming machine payout. For example, a gaming machine including the computing arrangement 200 also may include a payout controller 242 configured to receive a signal from the processor 202 indicating a payout is to be made to a player and controlling a payout device 244 to facilitate payment of the payout to the player. In some embodiments, the payout controller 242 may independently determine the amount of payout to be provided to the participant or player. In other embodiments, the payout controller 242 may be integrally implemented with the processor 202. The payout controller 242 may be a hopper controller, a print driver, credit-transmitting device, bill-dispensing controller, accounting software, or other controller device configured to verify and/or facilitate payment to a player.

A payout or payment device 244 also may be provided in gaming machine embodiments, where the payout device 244 serves as the mechanism providing the payout to the player or participant. In some embodiments, the payout device may be a hopper, where the hopper serves as the mechanism holding the coins/tokens of the machine, and/or distributing the coins/tokens to the player in response to a signal from the payout controller 242. In other embodiments, the payout device 244 may be a printer mechanism structured to print credit-based tickets that may be redeemed by the player for cash, credit, or other casino value-based currency. In yet other embodiments, the payout device 244 may send a signal via the network server 228 or other device to electronically provide a credit amount to an account associated with the player, such as a credit card account or player loyalty account. The computing arrangement 200 also may include accounting data stored in one of the memory devices 204, 206. This accounting data may be transmitted to a casino accounting network or other network to manage accounting statistics for the computing arrangement or to provide verification data for the currency or currency-based tickets distributed by the payout device, such as providing the data associated with the bar codes printed on the currency-based tickets so they are identifiable as valid tickets for a particular amount when the player redeems them or inserts them in another gaming device.

The wager input module or device 246 (also referred to as credit input 246) represents any mechanism for accepting coins, tokens, coupons, bills, electronic fund transfer (EFT), tickets, credit cards, smart cards, membership/loyalty cards, etc., for which a participant inputs a wager amount. The wager input device 246 may include magnetic strip readers, bar code scanners, light sensors, or other detection devices to identify and validate physical currency, currency-based tickets, cards with magnetized-strips, or other medium inputted into the wager input device. When a particular medium is received in the wager input device 246, a signal may be generated to establish or increase an available credit amount or balance stored in the internal memory/storage of the computing device 200, such as in the RAM 204. Thereafter, specific wagers placed on games may reduce the available credit amount, while awards won may increase the available credit amount. It will be appreciated that the primary gaming software 232 may be able to control payouts via the payout device 244 and payout controller 242 for independently determined payout events.

Among other functions, the computing arrangement 200 provides an interactive experience to players via an input interface 222 and output devices, such as the display 211, speaker 230, etc. These experiences generally are controlled by gaming software 232 that controls a primary gaming activity of the computing arrangement 200. The gaming software 232 may be temporarily loaded into RAM 204, and may be stored locally using any combination of ROM 206, drives 212, CD ROM drives 214, flash memory, or other non-transitory computer-readable storage media known in the art. The primary gaming software 232 also may be accessed remotely, such as via the server 228 or the Internet.

The primary gaming software 232 in the computing arrangement 200 may be an application software module. According to embodiments of games 10, this software 232 provides a slot game or similar game of chance as described hereinabove. For example, the software 232 may present, by way of the display 211, representations of symbols to map or otherwise display as part of a slot-based game having reels, such as games 10. However, in other embodiments, the principles of this concept may be applied to poker games or other types of games of chance. Symbols appearing in one or more predefined combinations of symbol positions may be evaluated to determine awards based on a paytable. The software 232 may include instructions to provide other functionality as known in the art or as described and shown herein.

Illustrative, non-exclusive examples of inventive subject matter according to the present disclosure are described in the following enumerated paragraphs:

A. A reel-based wagering game method implemented on a gaming apparatus comprising a game display, a user interface, and a controller, the reel-based wagering game method comprising:

(1) displaying, by the game display, changing reels, wherein the changing reels comprise at least four reels;

(2) sequentially stopping, by the controller, the changing reels to display, by the game display, stopped reels, wherein each stopped reel comprises displayed game symbols;

(3) evaluating, by the controller, whether the displayed game symbols of the first X stopped reels correspond to a first predetermined arrangement of game symbols that lead to a first payout condition, wherein X is an integer corresponding to a minimum number of reels required to lead to any payout condition;

(4) responsive to the displayed game symbols of the first X stopped reels corresponding to the first predetermined arrangement of game symbols:
(4a) evaluating, by the controller, whether the displayed game symbols of the first X+1 stopped reels correspond to a second predetermined arrangement of game symbols that lead to a second payout condition;
(4b) responsive to the displayed game symbols of the first X+1 stopped reels not corresponding to the second predetermined arrangement of game symbols, evaluating, by the controller, whether the displayed game symbols of the (X+1)th stopped reel through the (X+X)th stopped reel correspond to a third predetermined arrangement of game symbols that lead to a third payout condition; and
(4c) responsive to the displayed game symbols of the first X+1 stopped reels corresponding to the second predetermined arrangement of game symbols, evaluating, by the controller, whether the displayed game symbols of the first X+2 stopped reels correspond to a fourth predetermined arrangement of game symbols that lead to a fourth payout condition; and

(5) responsive to one or more of the first payout condition, the second payout condition, the third payout condition, or the fourth payout condition having been satisfied, increasing, by the controller, a credit balance.

A1. The reel-based wagering game method of paragraph A, further comprising:

receiving physical currency or currency based structure;

increasing the credit balance based on receipt of the physical currency or the currency based structure; and

receiving an input to cause initiation of a payout associated with the credit balance.

A2. The reel-based wagering game method of any of paragraphs A-A1, wherein step (4b) further comprises alerting, by the gaming apparatus, a player that a new evaluation of payout begins with the (X+1)th stopped reel.

A2.1. The reel-based wagering game method of paragraph A2, wherein the alerting comprises visually alerting, by the game display.

A2.1.1. The reel-based wagering game method of paragraph A2.1, wherein the visual alerting comprises one or more of:

displaying, by the game display, a symbol; and

visually separating, by the game display, the Xth stopped reel and the (X+1)th stopped reel.

A3. The reel-based wagering game method of any of paragraphs A-A2.1.1, wherein the evaluatings are based on the displayed game symbols of stopped reels corresponding to one or more paylines or one or more multi-way payout schemes.

A4. The reel-based wagering game method of any of paragraphs A-A3,

wherein the evaluatings are based on the displayed game symbols of stopped reels corresponding to a plurality of paylines; and

wherein step (4b) further comprises alerting, by the gaming apparatus, a player that a new evaluation of payout associated with a first payline of the plurality of paylines begins with the (X+1)th stopped reel.

A4.1. The reel-based wagering game method of paragraph A4, wherein the alerting comprises visually alerting, by the game display.

A4.1.1. The reel-based wagering game method of paragraph A4.1, wherein the visual alerting comprises one or more of:

displaying, by the game display, a symbol; and

visually separating, by the game display, symbol positions of the Xth stopped reel and the (X+1)th stopped reel along the first payline.

A5. The reel-based wagering game method of any of paragraphs A-A4.1.1, further comprising:

responsive to the displayed game symbols of the first X stopped reels not corresponding to the first predetermined arrangement of game symbols, evaluating, by the controller, whether the displayed game symbols of the (X+1)th stopped reel through the (X+X)th stopped reel correspond to a fifth predetermined arrangement of game symbols that lead to a fifth payout condition.

A6. The reel-based wagering game method of any of paragraphs A-A5, wherein X is three, four, five, six, or more than six.

A7. The reel-based wagering game method of any of paragraphs A-A6, wherein the changing reels consists of six, seven, eight, nine, ten, or more than ten reels.

B. A gaming apparatus configured to implement a reel-based wagering game, the gaming apparatus comprising:

a game display configured to display at least a portion of game reels of the reel-based wagering game;

a user interface configured to receive user input for controlling and engaging with the reel-based wagering game;

a wager input device structured to receive physical currency or currency based structure, the currency or currency based structure establishing a credit balance, the credit balance being increasable and decreasable based at least on wagering activity received from a player via the user interface;

a cashout device configured to receive an input to cause an initiation of a payout associated with the credit balance; and

a controller operably coupled to the game display, the user interface, the wager input device, and the cashout device, wherein the controller is operable to:

(1) responsive at least to initiation of a play, cause the game display to display the game reels as changing reels;

(2) cause the game display to sequentially stop the changing reels to display stopped reels, wherein each stopped reel comprises displayed game symbols;

(3) evaluate whether the displayed game symbols of the first X stopped reels correspond to a first predetermined arrangement of game symbols that lead to a first payout condition, wherein X is an integer corresponding to a minimum number of game reels required to lead to any payout condition;

(4) responsive to the displayed game symbols of the first X stopped reels corresponding to the first predetermined arrangement of game symbols:
(4a) evaluate whether the displayed game symbols of the first X+1 stopped reels correspond to a second predetermined arrangement of game symbols that lead to a second payout condition;
(4b) responsive to the displayed game symbols of the first X+1 stopped reels not corresponding to the second predetermined arrangement of game symbols, evaluate whether the displayed game symbols of the (X+1)th stopped reel through the (X+X)th stopped reel correspond to a third predetermined arrangement of game symbols that lead to a third payout condition; and
(4c) responsive to the displayed game symbols of the first X+1 stopped reels corresponding to the second predetermined arrangement of game symbols, evaluate whether the displayed game symbols of the first X+2 stopped reels correspond to a fourth predetermined arrangement of game symbols that lead to a fourth payout condition; and

(5) responsive to one or more of the first payout condition, the second payout condition, the third payout condition, or the fourth payout condition having been satisfied, increase the credit balance.

B1. The gaming apparatus of paragraph B, wherein (4b) further comprises responsive to the displayed game symbols of the first X+1 stopped reels not corresponding to the second predetermined arrangement of game symbols, alert the player that a new evaluation of payout begins with the (X+1)th stopped reel.

B1.1. The gaming apparatus of paragraph B1, wherein alert the player comprises cause the game display to display a visual alert.

B1.1.1. The gaming apparatus of paragraph B1.1, wherein the visual alert comprises one or more of a symbol and a visual separation of the Xth stopped reel and the (X+1)th stopped reel.

B2. The gaming apparatus of any of paragraphs B-B1.1.1, wherein evaluations are based on the displayed game symbols of stopped reels corresponding to one or more paylines or one or more multi-way payout schemes.

B3. The gaming apparatus of any of paragraphs B-B2,

wherein evaluations are based on the displayed game symbols of stopped reels corresponding to a plurality of paylines; and

wherein (4b) further comprises responsive to the displayed game symbols of the first X+1 stopped reels not corresponding to the second predetermined arrangement of game symbols, alert the player that a new evaluation of payout associated with a first payline of the plurality of paylines begins with the (X+1)th stopped reel.

B3.1. The gaming apparatus of paragraph B3, wherein alert the player comprises cause the game display to display a visual alert.

B3.1.1. The gaming apparatus of paragraph B3.1, wherein the visual alert comprises one or more of a symbol and a visual separation between symbol positions of the Xth stopped reel and the (X+1)th stopped reel along the first payline.

B4. The gaming apparatus of any of paragraphs B-B3.1.1, wherein the controller is further operable to:

responsive to the displayed game symbols of the first X stopped reels not corresponding to the first predetermined arrangement of game symbols, evaluate whether the displayed game symbols of the (X+1)th stopped reel through the (X+X)th stopped reel correspond to a fifth predetermined arrangement of game symbols that lead to a fifth payout condition.

B5. The gaming apparatus of any of paragraphs B-B4, wherein X is three, four, five, six, or more than six.

B6. The gaming apparatus of any of paragraphs B-B5, wherein the game reels consist of six, seven, eight, nine, ten, or more than ten game reels.

B7. The gaming apparatus of any of paragraphs B-B6, wherein the controller is further operable to:

receive a signal from the wager input device indicating receipt of the physical currency or the currency based structure; and

increase the credit balance based on a currency value associated with the physical currency or the currency based structure.

B7.1. The gaming apparatus of paragraph B7, wherein the controller is further operable to:

receive a wager from the player on a game event, the wager decreasing the credit balance.

B8. The gaming apparatus of any of paragraphs B-B7.1, wherein the gaming apparatus is configured to perform the reel-based wagering game of any of paragraphs A-A7.

C. A gaming apparatus configured to implement a reel-based wagering game, the gaming apparatus comprising:

a game display; and

a controller programmed to:
display, on the game display, a number of game reels; and
evaluate payout conditions based on multiple paylines or a multi-way payout scheme associated with the number of game reels, wherein evaluation of the payout conditions resets at a subsequent reel to stop after a first set of reels to stop results in a payout condition and the subsequent reel to stop does not correspond to a payout condition with the first set of reels to stop.

C1. The gaming apparatus of paragraph C, further comprising:

a wager input device structured to receive wagering activity from a player; and

wherein the controller is further configured to increase and decrease a credit balance based on the wagering activity and based on payouts resulting from evaluations of the payout conditions.

C2. The gaming apparatus of any of paragraphs C-C1, further comprising any suitable subject matter of any of paragraphs A-B8.

D. A gaming apparatus configured to implement a reel-based wagering game, the gaming apparatus comprising:

a game display; and

a controller programmed to:
display, on the game display, a number of game reels; and
evaluate payout conditions based on multiple paylines associated with the number of game reels, wherein evaluation of the payout conditions along a single payline resets at a subsequent reel to stop after a first set of reels to stop results in a payout condition along the single payline and the subsequent reel to stop does not correspond to a payout condition along the single payline with the first set of reels to stop.

D1. The gaming apparatus of paragraph D, further comprising:

a wager input device structured to receive wagering activity from a player; and

wherein the controller is further configured to increase and decrease a credit balance based on the wagering activity and based on payouts resulting from evaluations of the payout conditions.

D2. The gaming apparatus of any of paragraphs D-D1, further comprising any suitable subject matter of any of paragraphs A-C2.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

1. A reel-based wagering game method implemented on a gaming apparatus comprising a game display, a user interface, and a controller, the reel-based wagering game method comprising:
(1) displaying, by the game display, changing reels, wherein the changing reels comprise at least four reels;
(2) sequentially stopping, by the controller, the changing reels to display, by the game display, stopped reels, wherein each stopped reel comprises displayed game symbols;
(3) evaluating, by the controller, whether the displayed game symbols of the first X stopped reels correspond to a first predetermined arrangement of game symbols that lead to a first payout condition, wherein X is an integer corresponding to a minimum number of reels required to lead to any payout condition;
(4) responsive to the displayed game symbols of the first X stopped reels corresponding to the first predetermined arrangement of game symbols:
(4a) evaluating, by the controller, whether the displayed game symbols of the first X+1 stopped reels correspond to a second predetermined arrangement of game symbols that lead to a second payout condition;
(4b) responsive to the displayed game symbols of the first X+1 stopped reels not corresponding to the second predetermined arrangement of game symbols, evaluating, by the controller, whether the displayed game symbols of the (X+1)th stopped reel through the (X+X)th stopped reel correspond to a third predetermined arrangement of game symbols that lead to a third payout condition; and
(4c) responsive to the displayed game symbols of the first X+1 stopped reels corresponding to the second predetermined arrangement of game symbols, evaluating, by the controller, whether the displayed game symbols of the first X+2 stopped reels correspond to a fourth predetermined arrangement of game symbols that lead to a fourth payout condition; and
(5) responsive to one or more of the first payout condition, the second payout condition, the third payout condition, or the fourth payout condition having been satisfied, increasing, by the controller, a credit balance.

2. The reel-based wagering game method of claim 1, further comprising:
receiving physical currency or currency based structure;
increasing the credit balance based on receipt of the physical currency or the currency based structure; and
receiving an input to cause initiation of a payout associated with the credit balance.

3. The reel-based wagering game method of claim 1, wherein step (4b) further comprises alerting, by the gaming apparatus, a player that a new evaluation of payout begins with the (X+1)th stopped reel.

4. The reel-based wagering game method of claim 3, wherein the alerting comprises visually alerting, by the game display.

5. The reel-based wagering game method of claim 4, wherein the visual alerting comprises one or more of:
displaying, by the game display, a symbol; and
visually separating, by the game display, the Xth stopped reel and the (X+1)th stopped reel.

6. The reel-based wagering game method claim 1, wherein the evaluatings are based on the displayed game symbols of stopped reels corresponding to one or more paylines or one or more multi-way payout schemes.

7. The reel-based wagering game method of claim 1,
wherein the evaluatings are based on the displayed game symbols of stopped reels corresponding to a plurality of paylines; and
wherein step (4b) further comprises alerting, by the gaming apparatus, a player that a new evaluation of payout associated with a first payline of the plurality of paylines begins with the (X+1)th stopped reel.

8. The reel-based wagering game method of claim 7, wherein the alerting comprises visually alerting, by the game display.

9. The reel-based wagering game method of claim 8, wherein the visual alerting comprises one or more of:
displaying, by the game display, a symbol; and
visually separating, by the game display, symbol positions of the Xth stopped reel and the (X+1)th stopped reel along the first payline.

10. The reel-based wagering game method of claim 1, further comprising:
responsive to the displayed game symbols of the first X stopped reels not corresponding to the first predetermined arrangement of game symbols, evaluating, by the controller, whether the displayed game symbols of the (X+1)th stopped reel through the (X+X)th stopped reel correspond to a fifth predetermined arrangement of game symbols that lead to a fifth payout condition.

11. The reel-based wagering game method of claim 1, wherein X is at least three.

12. The reel-based wagering game method of claim 1, wherein the changing reels consists of ten or more reels.

13. A gaming apparatus configured to implement a reel-based wagering game, the gaming apparatus comprising:
a game display configured to display at least a portion of game reels of the reel-based wagering game;
a user interface configured to receive user input for controlling and engaging with the reel-based wagering game;
a wager input device structured to receive physical currency or currency based structure, the currency or currency based structure establishing a credit balance, the credit balance being increasable and decreasable based at least on wagering activity received from a player via the user interface;
a cashout device configured to receive an input to cause an initiation of a payout associated with the credit balance; and
a controller operably coupled to the game display, the user interface, the wager input device, and the cashout device, wherein the controller is operable to:
(1) responsive at least to initiation of a play, cause the game display to display the game reels as changing reels;
(2) cause the game display to sequentially stop the changing reels to display stopped reels, wherein each stopped reel comprises displayed game symbols;
(3) evaluate whether the displayed game symbols of the first X stopped reels correspond to a first predetermined arrangement of game symbols that lead to a first payout condition, wherein X is an integer corresponding to a minimum number of game reels required to lead to any payout condition;
(4) responsive to the displayed game symbols of the first X stopped reels corresponding to the first predetermined arrangement of game symbols:
(4a) evaluate whether the displayed game symbols of the first X+1 stopped reels correspond to a second predetermined arrangement of game symbols that lead to a second payout condition;
(4b) responsive to the displayed game symbols of the first X+1 stopped reels not corresponding to the second predetermined arrangement of game symbols, evaluate whether the displayed game symbols of the (X+1)th stopped reel through the (X+X)th stopped reel correspond to a third predetermined arrangement of game symbols that lead to a third payout condition; and
(4c) responsive to the displayed game symbols of the first X+1 stopped reels corresponding to the second predetermined arrangement of game symbols, evaluate whether the displayed game symbols of the first X+2 stopped reels correspond to a fourth predetermined arrangement of game symbols that lead to a fourth payout condition; and
(5) responsive to one or more of the first payout condition, the second payout condition, the third payout condition, or the fourth payout condition having been satisfied, increase the credit balance.

14. The gaming apparatus of claim 13, wherein (4b) further comprises responsive to the displayed game symbols of the first X+1 stopped reels not corresponding to the second predetermined arrangement of game symbols, alert the player that a new evaluation of payout begins with the (X+1)th stopped reel.

15. The gaming apparatus of claim 14, wherein alert the player comprises cause the game display to display a visual alert.

16. The gaming apparatus of claim 15, wherein the visual alert comprises one or more of a symbol and a visual separation of the Xth stopped reel and the (X+1)th stopped reel.

17. The gaming apparatus of claim 13, wherein evaluations are based on the displayed game symbols of stopped reels corresponding to one or more paylines or one or more multi-way payout schemes.

18. The gaming apparatus of claim 13,
wherein evaluations are based on the displayed game symbols of stopped reels corresponding to a plurality of paylines; and
wherein (4b) further comprises responsive to the displayed game symbols of the first X+1 stopped reels not corresponding to the second predetermined arrangement of game symbols, alert the player that a new evaluation of payout associated with a first payline of the plurality of paylines begins with the (X+1)th stopped reel.

19. The gaming apparatus of claim 18,
wherein alert the player comprises cause the game display to display a visual alert; and
wherein the visual alert comprises one or more of a symbol and a visual separation between symbol positions of the Xth stopped reel and the (X+1)th stopped reel along the first payline.

20. A gaming apparatus configured to implement a reel-based wagering game, the gaming apparatus comprising:
a game display; and
a controller programmed to:
display, on the game display, a number of game reels; and
evaluate payout conditions based on multiple paylines or a multi-way payout scheme associated with the number of game reels, wherein evaluation of the payout conditions resets at a subsequent reel to stop after a first set of reels to stop results in a payout condition and the subsequent reel to stop does not correspond to a payout condition with the first set of reels to stop.
